(19) United States
(12) Patent Application Publication
(10) Pub. No.: US 2016/0120150 A1
(43) Pub. Date: May 5, 2016

(54) MULTI ACTION PET PUZZLE TOY AND FOOD DISPENSER

(71) Applicants: Keith Mullin, La Jolla, CA (US); Johnny Liao, Irvine, CA (US)

(72) Inventors: Keith Mullin, La Jolla, CA (US); Johnny Liao, Irvine, CA (US)

(21) Appl. No.: 14/528,720

(22) Filed: Oct. 30, 2014

(51) Int. Cl. A01K 15/02; A01K 5/00

(52) U.S. Cl. CPC A01K 15/025; A01K 5/00

(57) ABSTRACT

The invention comprises a novel pet puzzle toy and food dispenser in which treats are located in receptacles wherein retrieval requires the pet to both spin and rock the puzzle in order to obtain the food. Much like a child's teeter totter, the food will end up in the receptacle with the greater weight as a result of pressure applied by a pet. The pet is both rewarded and entertained.

### FIELD

The invention relates to a novel pet puzzle toy and food dispenser in which treats are located in receptacles wherein retrieval requires the pet to both spin and rock the puzzle in order to obtain the food.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet puzzle toy and food dispenser in which treats are located in receptacles wherein retrieval requires the pet to both spin and rock the puzzle in order to obtain the food. As in a teeter totter or see-saw.

It is well known in the animal behavior sciences that is a dog doesn't get the mental stimulation it needs it will develop behavior problems such as chewing, biting or elimination in the home due to boredom, stress or depression. Veterinary science has also determined that in addition to behavioral problems, a dog will also be more prone to diseases as the immune system can weaken due to stress or depression. Thus it is key to challenge a dog with activities such as the inventive puzzle.

### THE INVENTION

### SUMMARY, OBJECTS AND ADVANTAGES

All who studied any form of psychology in school remember Pavlov's Dogs. A simple conditioning test resulted in dogs remembering or being cognitive of being given a treat when a bell was rung. Thus the dogs would respond in various cognitive ways when a bell was rung. This behavior presented itself for months after the actual tests were ceased. Pavlov evidenced that dogs actually had memory and the ability to react to certain stimuli on a consistent basis.

In the inventive toy, there are three “arms” which are affixed atop a gimbal that allows the arm component to both rotate and pitch as in a teeter totter.

Below the arms portion is a flanged perimeter dish which aids in stabilization of the puzzle toy.

The inside of the arms are hollow to allow flow through of food or treats, and in the center is an intake receptacle for a user to add food.

Treats or food will then respond to gravity and standard kinetics when a downward force is initiated by the pet onto any of the three arms. Resulting from the weight of dispensed food, the arm will tilt to the corresponding heavy side and the pet can consume the food.

### BRIEF DESCRIPTION OF THE DRAWINGS

The invention is described in further detail by reference to three (3) drawings sufficient in detail to describe the invention in which:

FIG. 1 is a perspective view of the puzzle toy at rest with food in one arm; and

FIG. 2 is a top view of the puzzle toy illustrating the tri-armed top portion and food receptacles; and

FIG. 3 is an illustration of the toy in action when a pet places pressure on one arm of the tri-arm top portion.

### DETAILED DESCRIPTION, INCLUDING BEST MODES OF CARRYING OUT THE INVENTION

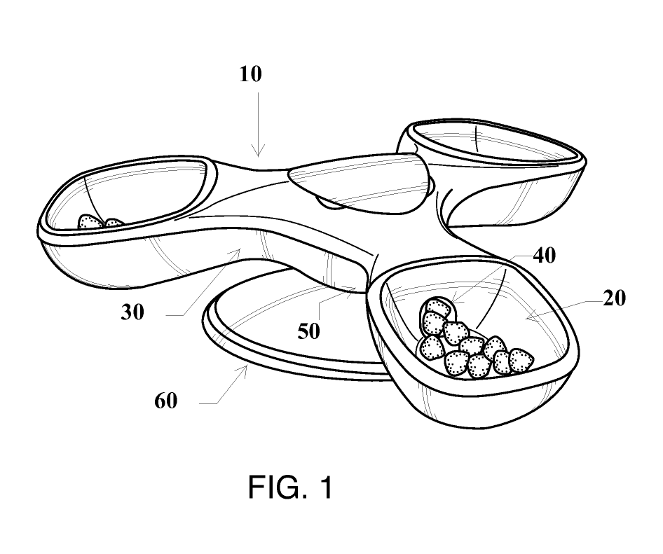

FIG. 1 illustrates the puzzle toy and food dispenser 10 at rest with food 20 demonstrated in one treat receptacle. The arms 30 have indentations wherein food will fall from an aperture 40 at each end of the arm and rest in the indentation. The arm top portion rests on a gimbal and hinge set 50 which is not completely illustrated in this Fig., but allows the arm portion to both rotate and hinge toward the indentation that has the greatest weight. As in a child's teeter totter. A base 60 with a flanged perimeter stabilizes the entire puzzle toy and food dispenser.

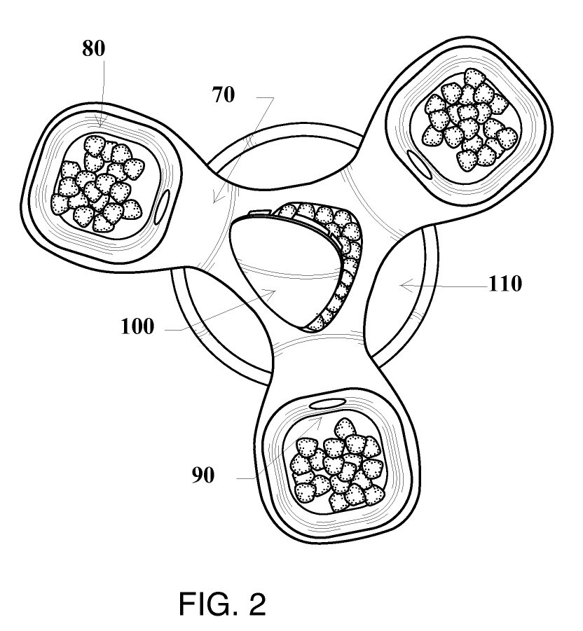

FIG. 2 is an aerial view and shows the arm shaped tri-arm 70 and the receptacles 80 for food to be dispensed as a pet causes the arm to move downward. As the end with pressure applied moves downward, food kibbles will travel through the hollow arm portion and emit from apertures 90 located on each end of the arm. An aperture on top of the arm 100 allows a user to insert food which will then travel down one end of the arm or the other. An aerial view of the base 110 illustrates the flanged perimeter which stabilizes the puzzle toy and food dispenser.

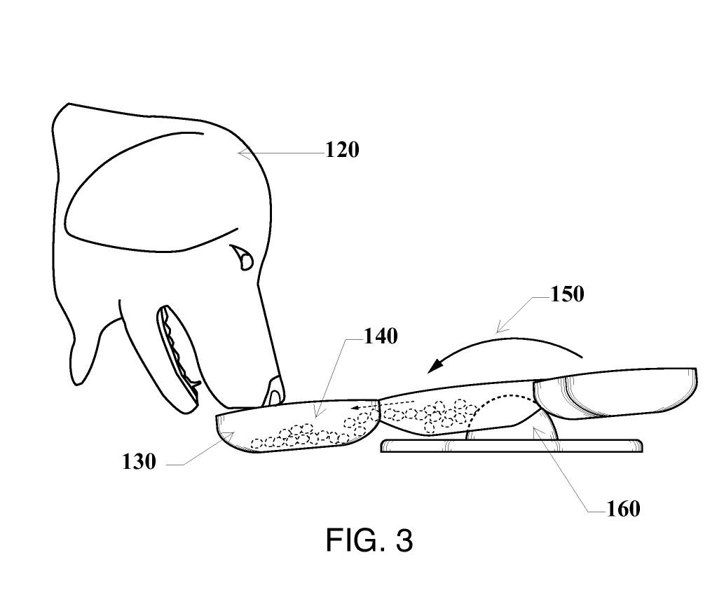

FIG. 3 is a side perspective showing a dog 120 placing pressure one on of the arms 130. This in turn causes the arm to tilt downward 140 and allow food kibbles 150 to slide into the receptacle 160 via gravity. The ball joint style gimbal 170 allows for the toy to lean and spin depending upon the animal's interaction with the toy.

1) A pet puzzle toy and food dispenser;
a) a base piece
b) a tri-arm top piece
c) a gimbal and hinge
d) receptacles for food
e) an aperture for food insertion

2) A pet puzzle toy and food dispenser as in claim 1 wherein the base piece is a circular shape with flanged perimeter so as to create a sidewall to the base, and the base houses a gimbal and hinge.

3) A pet puzzle toy and food dispenser as in claim 1 wherein the top piece comprises a tri-arm top portion, wherein each arm is hollow and which is affixed to the gimbal centered on the base.

4) A pet puzzle toy and food dispenser as in claim 1 wherein a gimbal and ball joint hinge set allows both tilting and rotating motion of the arm piece.

5) A pet puzzle toy and food dispenser as in claim 1 wherein the receptacles for food terminate at the end of the hollow tunnel of each arm end, and which respond to weight of food and gravity to tilt in favor of the end with greater weight in the receptacle.

6) A pet puzzle toy and food dispenser as in claim 1 wherein an aperture is located in the center top of the arm piece and which allows a user to insert a desired amount of pet food.
